(19) United States
(12) Patent Application Publication
(10) Pub. No.: US 2007/0283626 A1
(43) Pub. Date: Dec. 13, 2007

(54) OPENING AND SHUTTING MECHANISM FOR A WINDOW

(76) Inventor: Ernesto Tedeschi Neto, Joinville (BR)

Correspondence Address: HUGHES HUBBARD & REED LLP, ONE BATTERY PARK PLAZA, NEW YORK, NY, 10004, US

(21) Appl. No.: 11/684,083

(22) Filed: Mar. 9, 2007

(30) Foreign Application Priority Data
Jun. 13, 2006 (BR) PI 0602283-9

(51) Int. Cl. E05C 17/00

(52) U.S. Cl. 49/141

(57) ABSTRACT

The present invention refers to a mechanism for the opening and for the shutting of a window, particularly designed for use in the emergency windows of a public transportation vehicle provided with a lower release and locking window (1) system and another upper system that allows for the scaling when opening it, considering the fact that the lower system is actuated by means of a lever (5) that extends along the lower extremity of the window (1), which allows for its actuation by any passenger positioned in its proximity.

### FIELD OF THE INVENTION

The present invention refers to an opening and shutting mechanism for a window, particularly designed for use in the emergency windows of public transportation vehicles, such as buses.

For ease of reference the following description illustrates the invention in a particular embodiment which is an opening and shutting mechanism particularly designed for use in the emergency windows of public transportation vehicles, but it must be understood that the use of said mechanism is not necessarily limited to buses and it can also be used in trailers, automobiles, trains, sea going vessels, etc., with no restrictions regarding the type of glass to be used on the window (i.e. plain, curved, tempered, laminated, two folded glass or double glazing glass, etc.).

### BACKGROUND OF THE INVENTION

The emergency window is a vehicular safety item that is primarily necessary for public transportation vehicles carrying passengers and it is thus regulated in a variety of different manners.

In Brazil as well as abroad, a mechanism is provided which generally consists of levers duly placed on the columns to the left and to the right of the window for the necessary opening in the case of an emergency. Above all, this mechanism is employed on the bodywork of vehicles predominantly for urban use.

With regards to the European Regulations, where in many cases the glass window is a two folded or double-glazed glass, the use of a hammer in order to break the glass, and thus allow for an emergency exit, is permitted. Above all this system is used in road buses and in those equipped with fixed or stuck-on glass windows.

Amongst the well known emergency windows opening and operational systems there is the “push out” type that basically is a lever set on the side columns of the window, which when acted upon push the window towards the outer side of the vehicle.

Thus the operational systems for the opening of emergency windows are designed and built considering passengers safety and are frequently subject to regulation restrictions that limit their functional characteristics.

In the case of windows, which are broken with a hammer, even though being a system that does not fail, it is not a very convenient one due to the fact that glass shards may injure the passengers. Further more, there is the cost for glass re-installation and the recovery of the parts in the immediate vicinity that may eventually be damaged, entailing more loss and additional costs for the proprietor of the vehicle.

The present window “push out” system, commonly employed on the urban buses, is provided with two levers placed on the side columns to the window and thus presents a number of inconveniences. As it is an easily removable window system, it is also very easy to be stolen. Another disadvantage is the very fact it cannot simply be used in any window merely due to the fact that buses do have a series of obstacles/restrictions regarding the positioning of the levers such as the seats backside, the place where the bus fare collector seats, the handrails, the protective screens, the luggage compartments above the seats and other limitation factors; therefore not every vehicle window may serve and function as an emergency window.

There are other emergency window systems of the “push-out” type in accordance to the regulations and the standards established by the FMVSS 217 (Federal Motor Vehicle Safety Standards and Regulations), which employs mechanisms consisting of steel cables or locks in a similar manner to that of automobiles but, disadvantageously, it means not only something extremely costly and also of a rather complex maintenance as well as manufacturing.

In order to ease the problems of the emergency exits that utilize hammers to break the glass windows, tempered glass is used. When broken, this type of glass tends to produce and form smaller and less sharply pointed glass shards than the common glass ones, but still the glass shards can be harmful and injure the passengers. Further more, they represent an additional cost to the proprietor when re-installing it due to the very fact they are more expensive than normal glass.

The following documents and patent applications are representatives of the state of the art that deals with window locking systems for vehicles.

### THE STATE OF THE ART

The North American patent No. U.S. Pat. No. 3,927,492 refers to a fast releasing window system consisting of articulated between itself parts which can be manually activated in order to release the vehicle's window thus providing an emergency exit. The system comprises of an external structure in a frame, which supports one window and said structures are connected between them on the upper portion by means of an articulation that allows for the balance of the very windows. In a different manner from the present invention, this document presents a mechanism on the lower portion of the frame of the vehicle's wall opening provided with a lever connected to a locking bar by means of a pair of articulated members in between. Thus in a more complex form than the present invention this document presents a mechanism that is dependent on the correct and exact articulation of four parts between the locking and unlocking position.

The North American patent No. U.S. Pat. No. 3,942,286 presents a fast release window system for a vehicle consisting of an elongated locking bar assembled in a pivot manner to the base of one of the window's frame and it is manually operable between the coupling and decoupling bar in one edge of the wall's opening frame. The upper portion of the window frame is assembled on the wall's opening frame by means of hinges that allows for the balance of the window when the bar is unlocked in relation to the referred edge of the wall's opening frame. This system is much simpler than the previous one but in a disadvantageous manner it does not present any obstacle to the accidental unlocking of the bar.

The North American patent No. U.S. Pat. No. 4,313,280 presents a quick release window system similar to the one of the North American patent No. U.S. Pat. No. 3,942,286, in which the window is provided with a profile along its lower base that is kept against an edge fixed to the base of the vehicle's opening. In order to open it the profile is pushed upwards thus releasing the window. Differently from the present invention, this document presents a practically instantaneous opening not presenting any obstacle to the accidental unlocking of the bar.

The North American patent No. U.S. Pat. No. 5,941,022 relates to a window locking system for an emergency exit provided with a lock assembled on the frame of a window which can be moved between the locked and unlocked positions, one tension spring which tilts the locking member to the unlocked position, one locking element which allows for the switching between locked and unlocked positions and a second tension spring that tilts the locking element to its unlocked position. This patent application presents a rather better system than the patent applications previously cited due to the fact it offers a certain resistance to the unlocking position however it is more complex than the previous ones.

Therefore, in order to solve the state of the art previous problems, the present opening and shutting mechanism for windows of the “push-out” type with low cost for manufacturing, maintenance and installation has been developed. The present mechanism also fulfils the so defined North American Regulation 49 CFR 571.217, “BUS EMERGENCY EXITS AND WINDOW RETENTION AND RELEASE”.

### OBJECTIVES OF THE INVENTION

It is an objective of the present invention to provide a mechanism which dispenses with the levers placed on the side columns to the window and which can be actuated from any point along its length.

It is yet another objective of the present invention to provide one emergency window mechanism provided with a lower rotating lever which can be easily actuated by the very passenger.

It is still another objective of the present invention to provide a locking mechanism with two stages in order to keep the window leaning against the vehicle even after the unlocking procedure.

### BRIEF DESCRIPTION OF THE INVENTION

The present invention is related to a mechanism fitted on emergency windows of the “push-out” type in which the activating means is a lower lever that extends along the whole lower edge of the very window.

Once manually activated the rotating lever fitted along the lower edge of the window unlocks the window's glass from its shutting position thus making it possible to be manually pushed towards the outer side of the vehicle.

The window is coupled to the vehicle, by its upper portion by means of hook shaped profiles which permits for its setting and its scaling movement without releasing the window. The upper profile of the window is provided with an enlargement or widening of its medium portion which functions as an opening movement limitation factor.

From this opening limitation factor it is necessary to disengage the window profile from the vehicle's profile in order to remove it.

In order to release the window the user must actuate the lever upwards. Following this the user must push the glass outwards so that the window may open towards the outer side.

In the case of an involuntary actuation of the lever without the window glass being pushed towards the outer side, all there is to be done is to push the lever down returning it to the initial position, thus locking the window again. In case the glass had been opened towards the outside, the user must bring it back against the bus by closing the window and after that push the lever in a downwards direction.

The developed mechanism allows for the window to be once again retained in its original position following an inverse sequence of activation.

With regards to aesthetics terms, this window does not present any differences to the window with a stuck-on glass; therefore it does not affect its appearance or the design of the vehicle.

This activating mechanism was designed to make use of low cost components, but nevertheless guaranteeing water tightness and suspended particles (dust, powder, etc.) tightness, and also in order to facilitate its installation and adjustment when in the production line.

By employing a lever that extends along the whole lower edge of the window, a prompt and ready access to the mechanism is guaranteed thus being at the reach of any passenger sitting next to the window. This very fact eliminates the inconvenience of having to look for a breaking hammer or a lever, when confronted with an emergency situation.

The necessary level of strength to actuate on the mechanism is not substantial—not being greater than 9 kgf, an amount which really facilitates the opening of the window by any passenger at all capable of doing so.

The unlocking procedure is done in two stages, which reduces the possibility of involuntary opening of the window.

Additionally, the mechanism may comprise a device that supports the window in its opened position in order to facilitate the escaping and probable rescuing of the passengers.

With the sole aim of facilitating the visualization of the present invention window opening and shutting mechanism, the following schematic figures of a possible embodiment are hereby presented in which the dimensions and the proportions are not necessarily real due to the fact the figure's main purpose is to didactically present the innovative variety of aspects which the protection inclusion is only determined by the scope of the annexed claims.

### BRIEF DESCRIPTION OF THE DRAWINGS

FIG. 1 shows a frontal view of a window with the shutting mechanism of the present invention fitted on a vehicle.

FIG. 2 shows a transversal section view according to the line A-A of FIG. 1.

FIG. 3 shows an enlarged view of the detail “W” of FIG. 2.

FIG. 4 shows an enlarged view of the detail “X” of FIG. 2.

FIG. 5 shows a view of a window with the mechanism of the present invention.

FIG. 6 shows transversal section view according to the line B-B of the window from FIG. 5.

FIG. 7 shows an enlarged view of the detail “Y” of FIG. 6.

FIG. 8 shows an enlarged view of the detail “Z” of FIG. 6.

FIG. 9 shows a perspective view of the opening mechanism of the present invention.

### DETAILED DESCRIPTION OF THE INVENTION

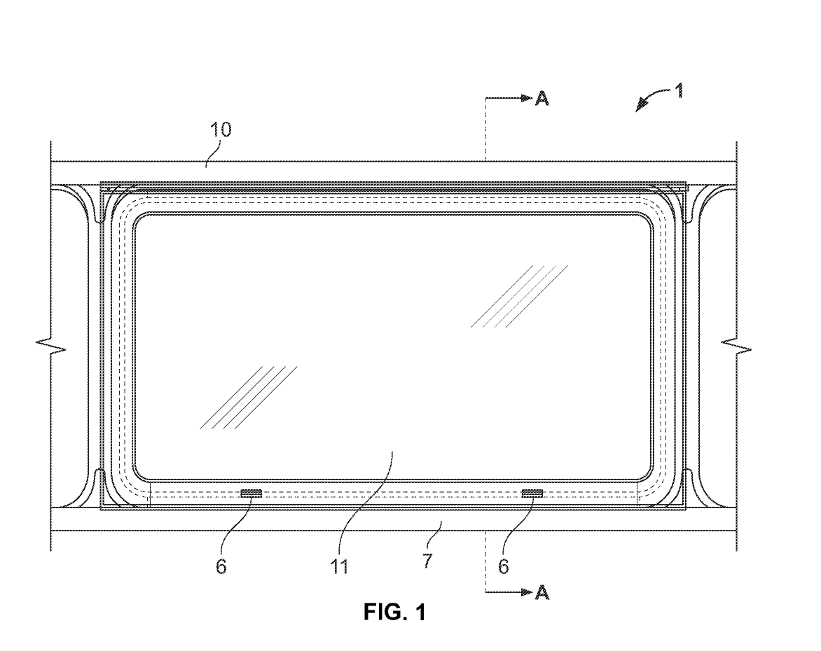

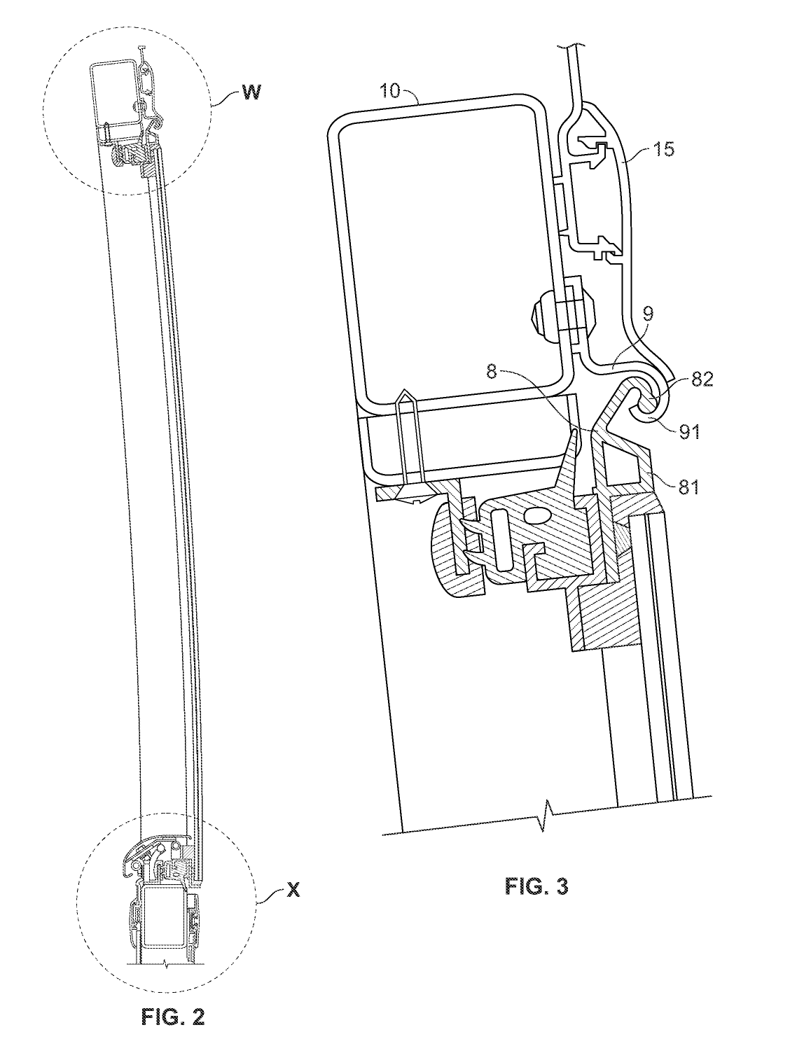

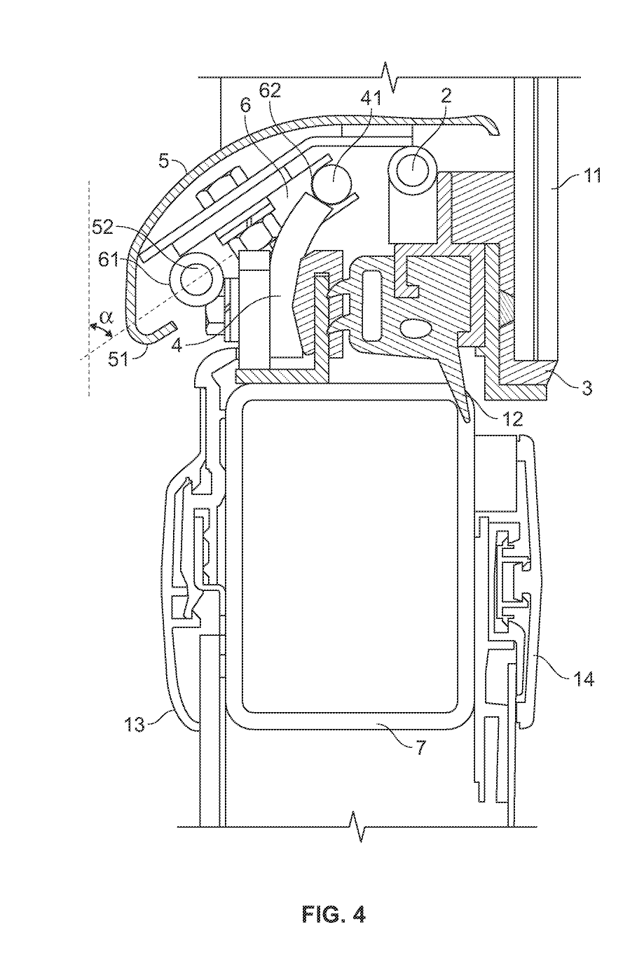

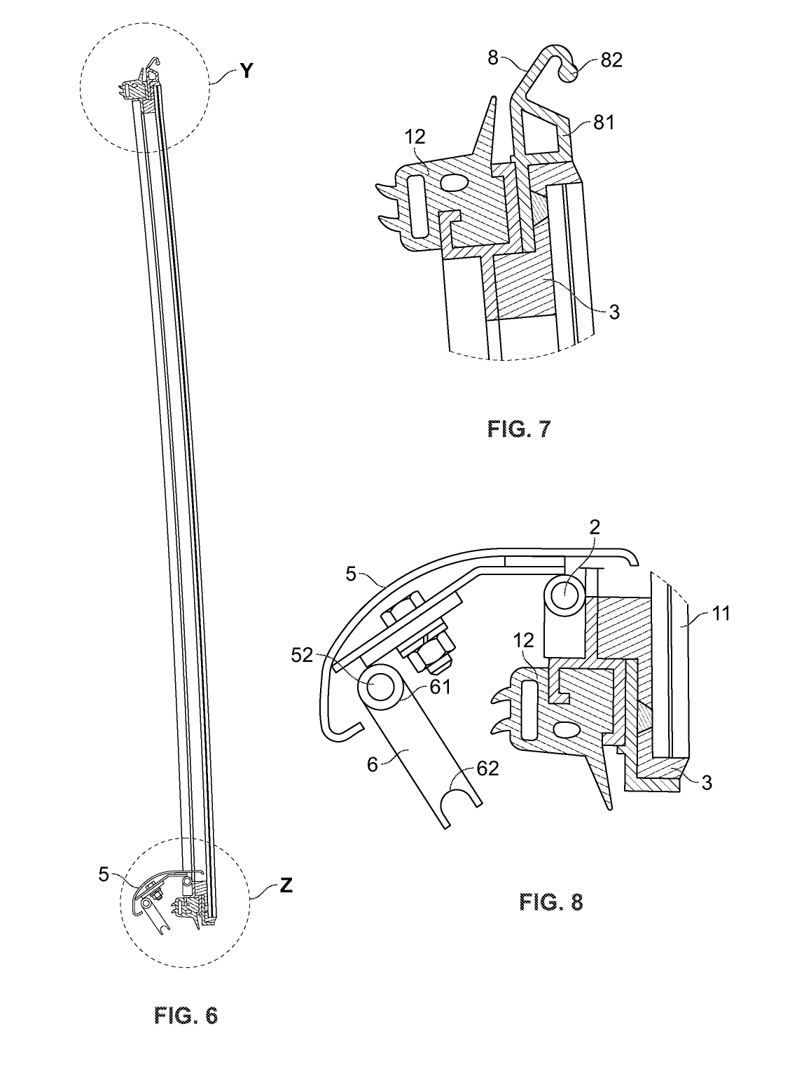

The present invention refers to a window opening and shutting mechanism placed on the lower part of the window (1) in the inner side of the vehicle (not illustrated), as it is better illustrated by the FIGS. 1, 4, 5, 6 and 8. The mechanism comprises of a tripod (4) (FIG. 4) fixed to a lower profile (7) which frames the lower portion of the opening for the window (1); a longitudinal lever (5) fixed to the lower extremity of the window's glass (11) by means of a fixture (2) that allows for the rotation in relation to the window (1) between the positions of locked and unlocked; a palette or a lock (6) that has one of its extremities (62) pressed against the upper portion (41) of the tripod (4) when the mechanism is locked, and its opposing extremity (61) is articulate with the lever (5) in such a manner that when the window (1) is closed and the lever (5) is turned towards the bottom, the palette or lock (6) is kept under pressure against the tripod (4) pulling the window (1) against the bodywork of the vehicle and thus locking it (FIG. 4).

The palette or lock (6) remains stable when the lever (5) is facing downwards, and preferably forming an angle (a) with the vertical line between 0° and 90°.

The means of fixation (2) of the lever (5) on the window (1) can be any, provided it permits the rotation of the lever (5) in relation to the window (1), for instance, a pin, an axle, a hinge, etc.

In order to unlock the mechanism one pushes the edge (51) of the lever (5) in an upward direction, which by its turn carries the palette or lock (6) along with it, rotating it around its extremity (52) releasing it from the tripod (4). At this very moment the window (1) is free and is released to be pushed towards the outside, taking with it the lever (5) and the palette or lock (6).

If the intention is not to open the window (1), in order to lock it against the vehicle's bodywork once again, all the user has to do is to push the lever (5) downwards, it in turn will push the palette or lock back to its initial locking position, that is to say, locked in relation to the tripod (4), thus keeping the window (1) closed.

The window (1) is supported by the vehicle's bodywork by its upper edge, by means of the co-operable fitting of a profile (8) of the window (1) in one profile (9) of the bodywork, both of them in the shape of a hook that thus allows for the window (1) to rotate around the fitting when unlocked. The fitting is made between a longitudinal profile fixed to the upper extremity of the glass (11) of the window (1) provided with an edge (82) in the shape of a hook along its length; and a profile (10) which frames the upper portion of the bodywork's opening to the window (1) provided with a hook (9) where the edge (82) is fitted keeping the window (1) in a hanging position. The hook (9) can be of a separately manufactured profile from the profile (10) and can be fixed to it afterwards.

The profile (8) comprises of a central widened portion (81) that functions like a window post for the window (1) limiting its opening.

As it is illustrated by the annexed figures the window (1) comprises of elastomeric profiles (gaskets) (3 and 12) that extend along the edge of the glass (11), which prevents against the water entering the interior of the vehicle (not illustrated) and the finishing profiles (13, 14 and 15) of the finishing touches of the window (1).

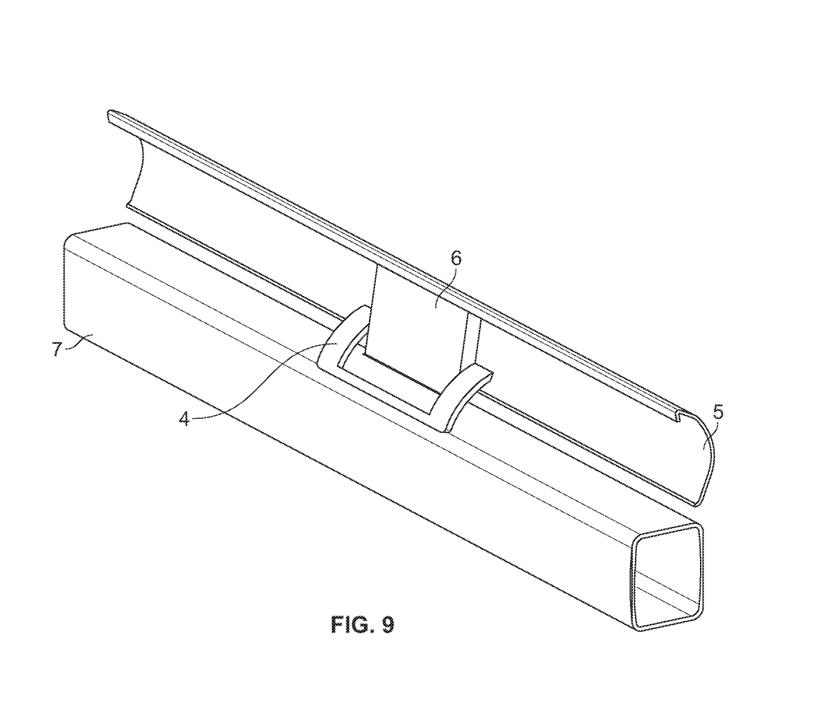

FIG. 9 presents a perspective view of the lever (5) turned upwards and the palette or lock (6) supported on the tripod (4) before the window (1) is opened. To facilitate the visualization of the present mechanism, this figure does not present the finishing frames (13 and 14) of the bodywork openings and the gaskets (3 and 12) of the window (1).

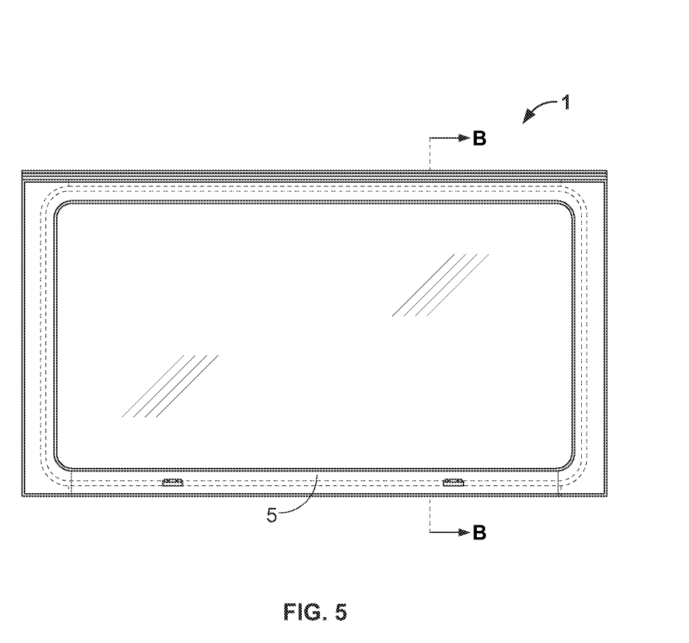

The window may comprise of one or more tripods (4) and palette or lock (6) associated with the lever (5), preferably two tripods (4) and corresponding palettes or locks (6) as it is illustrated in the FIGS. 1 and 5, which thus offer a better closing for the window (1).

The artisan with ordinary skills in the art will promptly perceive from the exposed description, as well as from the figures and drawings hereby shown, that there are a variety of manners to realize the invention without departing from the scope of the annexed claims.

I claim:

1. A mechanism for the opening and shutting of a window which comprises the following features: a tripod (4) fixed to a lower profile (7) that frames the opening for the window (1); a longitudinal lever (5) fixed to the lower extremity of the glass (11) of the window (1) by means of a fixture that allows for its rotation in relation to the window (1); a palette or a lock (6) which has one of its extremities (62) pressed against the upper portion (41) of the tripod (4) when the mechanism is locked, and its opposing extremity (61) is articulate with the lever (5) in such a manner that when the window (1) is closed and the lever is facing downwards, the palette or lock (6) is kept under pressure against the tripod (4).

2. A mechanism for the opening and shutting of a window according to the claim number 1 which has the feature that when the mechanism is locked the palette or lock (6) forms an angle (α) with the vertical line between 0° and 90°.

3. A mechanism for the opening and shutting of a window according to the claim number 1 which has the feature that the window (1) comprises of elastomeric profiles (gaskets) (3 and 12) that extend along the edge of the glass (11) in order to prevent against water entering the interior of the vehicle.

4. A mechanism for the opening and shutting of a window according to the claim number 1 which has the feature that the window (1) is supported by the vehicle's bodywork by means of a co-operable fitting of a profile (8) of the window (1) in a profile (9) of the bodywork, both in the shape of a hook, which thus allows for the window (1) to rotate around the fitting when unlocked; in which the longitudinal profile (8) is fixed to the upper extremity of the glass (11) of the window (1) provided with an edge (82) in the shape of a hook along its length; and the profile (9) in the shape of a hook fixed to a profile (10) that frames the upper part of the opening of the bodywork to the window (1).

5. A mechanism for the opening and shutting of a window according to the claim number 4 which has the feature that the profile (9) is incorporated to the profile (10).

6. A mechanism for the opening and shutting of a window according to the claim number 1 which has the feature that it comprises finishing profiles (13, 14 and 15) of finishing touches for the opening of the bodywork to the window (1).

7. A mechanism for the opening and shutting of a window according to the claim number 4 which has the feature that the profile (8) is provided with a central widened portion that functions like a window post for the window (1) limiting its opening.
